(19) United States
(12) Patent Application Publication
(10) Pub. No.: US 2022/0116212 A1
(43) Pub. Date: Apr. 14, 2022

(54) PROCESS FOR MONOVALENT ONE-TO-ONE EXTRACTION OF KEYS FROM THE PROPAGATION CHANNEL

(71) Applicants: THALES, COURBEVOIE (FR); INSTITUT MINES TELECOM, PARIS (FR); CELENO COMMUNICATIONS LTD, RA'ANANA (IL)

(72) Inventors: Renaud MOLIÈRE, GENNEVILLIERS CEDEX (FR); Christiane KAMENI NGASSA, GENNEVILLIERS CEDEX (FR); François DELAVEAU, GENNEVILLIERS CEDEX (FR); Claude LEMÉNAGER, GENNEVILLIERS CEDEX (FR); Alain SIBILLE, PARIS CEDEX (FR); Taghrid MAZLOUM, PARIS CEDEX (FR); Nir SHAPIRA, RA'ANANA (IL)

(21) Appl. No.: 17/465,067

(22) Filed: Sep. 2, 2021

Related U.S. Application Data
(63) Continuation of application No. 16/067,054, filed on Jun. 28, 2018, now abandoned.

(30) Foreign Application Priority Data
Dec. 29, 2015 (FR) 1502712

(51) Int. Cl. H04L 9/08; H04B 17/354; H04B 17/382; H04B 17/391

(52) U.S. Cl. CPC H04L 9/0875; H04B 17/354; H04B 10/00; H04B 17/391; H04L 63/0428; H04B 17/382

(57) ABSTRACT

A method for generating an encryption key is provided to encrypt data exchanged between a first user and a second user, wherein the key is determined from measurements of the transmission channel.

### CROSS-REFERENCE TO RELATED APPLICATIONS

This application is a continuation of U.S. patent application Ser. No. 16/067,054, filed Jun. 28, 2018, which is a National Stage of International patent application PCT/EP2016/082874, filed on Dec. 29, 2016, which claims priority to foreign French patent application No. FR 1502712, filed on Dec. 29, 2015, the disclosures of which are incorporated by reference in their entirety.

### FIELD OF THE INVENTION

The invention relates to a method for univalent and unequivocal extraction of keys from the propagation channel. These keys, which are made secret because of the univalency of the method, are intended to be used to secure the exchange of data between at least one first user and at least one second user, in a data exchange system, notably wireless communication systems (portable terminals, computers, etc.).

### BACKGROUND

For data exchanges, notably wireless communication systems, it is preferable to secure the information transmitted between two users, so as to prevent a malicious third party from accessing this information.

The majority of secure transmission systems use secret keys that are shared beforehand between the emitters and the receivers, this involving complex (and often expensive) mechanisms for generating and distributing said keys in order to share them between the users. In addition, when this generation and this distribution have to be performed on a large scale, such as for example in public radio communication networks, the increase in the parties involved (manufacturers, operators, distributors, subscribers) and in the routing circuits leads to strong risks of data leakage, as numerous recent events in the field have demonstrated.

There are some devices in existence for generating secret keys from the propagation channel. These devices use the received signal strength indication (RSSI). Technologically speaking, this strength measurement is fairly easy to access. However, the RSSI takes into account only a small part of the wealth of the propagation channel, ignoring the channel phase coefficients that offer a much more random nature than the single signal strength parameter that is usually utilized. On account of this, in frequent cases, generating a key by utilizing the RSSI is not univalent as the keys that are generated have high correlations, thereby enabling a third party to recover them.

### SUMMARY OF THE INVENTION

The idea behind the method according to the invention is notably to take full advantage of the highly random nature of wireless transmission channels so as to generate, in a univalent and unequivocal manner, a secret key for protecting data exchanged between at least one emitter and one receiver. Said univalency stems from the fact that just one measurement of the channel, performed simultaneously and at the same location, would allow a third party, who is not informed of said measurements, to reproduce these keys by applying the same selection, quantification and formatting procedures; said unequivocality stems from the formatting and correction mechanisms applied in the method according to the invention.

In the remainder of the description, the expression ‘user A’ or ‘transceiver A’ is used indiscriminately to refer to a user Alice and likewise for the user Bob.

The invention relates to a method for univalent and unequivocal extraction of keys from a propagation channel (EUC_CP), said keys being intended to protect data exchanged between a first user and a second user, a user including one or more emitters and one or more receivers, the data being transmitted via the propagation channel, characterized in that it comprises at least the following steps:
a) Measuring, by way of the receiver(s) of the first and of the second user, signals S coming from each emitter of the other user, measuring the parameters of the corresponding propagation channel, and estimating the corresponding complex impulse responses of the propagation channel or corresponding complex frequency responses of the propagation channel,
b) Selecting, in a univalent manner, for each user, a set of complex channel coefficients resulting from the estimations of the complex impulse responses of the propagation channel or of the complex frequency responses of the propagation channel, and retaining the coefficients that exhibit a cross-correlation lower than an adjustable predetermined threshold value,
c) Quantifying and formatting, for each user, the selected complex channel coefficients by applying a geometrical mesh of the complex plane in which the channel coefficients take their value, numbering the complex coefficients according to the mesh to which they belong, and by applying error correction techniques to said numbering,
d) Using, in a univalent and unequivocal manner, for each user, digital data resulting from said quantification and from said formatting in the form of secret keys so as to encrypt the string of transmitted data.

The method uses, for example, as communication mode between the users, a temporal duplex mode employing one and the same carrier frequency for the emission and reception exchanges in both transmission directions.

The method may be duplicated over all of the carrier frequencies employed by users in frequency duplex mode employing different carrier frequencies for their emission and reception exchanges according to the transmission direction.

The method may apply an error correction coding function to the keys that are extracted by the users, with minimal transmission of data from the first user to the second user, in order to eliminate the differences between the keys of the first and of the second user.

According to one variant embodiment, the method implements a hash function and a length reduction on the extracted keys, the function being designed to eliminate any residual leakage of information to a third party and improve the random qualities of the keys.

The steps of the method according to the invention may be repeated from one transmission to another and be repeated regularly over the course of one and the same transmission.

The method may use a noise and beamforming protocol for the transmission of the data, and the signals are for example signals that are emitted and received within the framework of said artificial noise and beamforming protocol.

According to one variant embodiment, the signals are signals that are emitted and received within the framework of a simultaneous emission and reception (‘full duplex’) protocol.

According to another variant, the signals are public or non-public, covert or non-covert, self-interfering or non-self-interfering marking signals that are emitted and received within the framework of a transceiver system identification protocol or within the framework of a user authentication protocol for such a system or within the framework of a protocol for verifying the integrity of the messages emitted and received by such a system.

The method may implement emitters and receivers adapted for radio communication. It may also use emitters and receivers adapted for acoustic transmissions or else for optical transmissions.

The invention also relates to a device for univalent and unequivocal extraction of keys from a propagation channel (EUC_CP), said keys being intended to protect data exchanged between a first user and a second user, a user including one or more emitters and one or more receivers, the data being transmitted via the propagation channel, characterized in that each user comprises at least one calculating unit adapted for executing the steps of the method according to the invention.

The emitters and the receivers are, for example, radio communication transceivers, or emitters and receivers adapted for acoustic transmissions or else emitters and receivers for optical transmissions.

### BRIEF DESCRIPTION OF THE DRAWINGS

Other features and advantages of the present invention will become more clearly apparent upon reading the description, given by way of wholly non-limiting illustration, alongside the appended figures, in which:

FIG. 1 shows a general diagram of exchanges of information between two users A (Alice) and B (Bob) in the presence of an outside third party E (Eve) who is not authorized to ascertain the content of the data exchanged between A and B,

FIG. 2 shows an illustration of the effects of a dispersive propagation channel on the transmission of the signals from an emitter (A) to an authorized receiver (B) and to an unauthorized receiver (E), and

FIG. 3 shows a diagram explaining a quantification algorithm for the propagation channel between the emitter A and the receiver B, after measurement thereof by B using methods that are well known to those skilled in the art.

### DETAILED DESCRIPTION

To better understand the method according to the invention, the example is given in the case of an exchange between a first transceiver user A (Alice) and a second transceiver user B (Bob), in the presence of an unauthorized third-party receiver E (Eve) liable to intercept the communications and to access the content of the data exchanged between A and B.

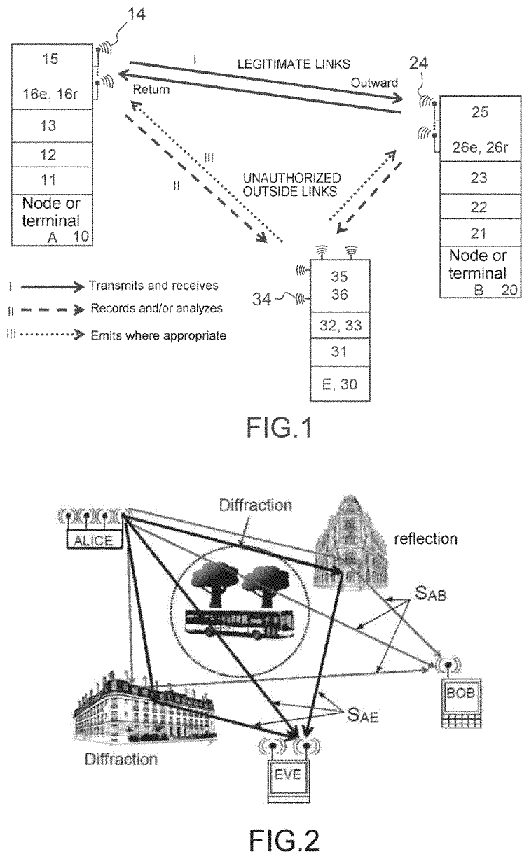

FIG. 1 illustrates a scenario of communication between a first user A, 10 and a second user B, 20 in the presence of an unauthorized third-party receiver E, 30.

The user A is for example a node or a terminal of a communication network including a calculating unit 11, a coding/decoding module 12, a demodulation module 13, a module formed of antennae 14, a set of filters 15 and radio emission and reception means 16e, 16r. These elements are known to those skilled in the art and will not be described in detail. The subject of the invention will consist notably in executing an algorithm for calculating a key by utilizing the measurements performed on the parameters of the channel, as will be explained hereinafter.

Likewise, the user B, 20 includes for example a calculating unit 21, a coding/decoding module 22, a demodulation module 23, and a module formed of antennae 24, of filters 25 and of radio emission and reception means 26e, 26r.

The unauthorized third-party receiver E, 30 includes a calculating unit 31, a data logger 32 and an analysis module 33, and a block of antennae 34 and of filters 35 and of radio reception means 36.

FIG. 2 outlines an example of existing propagation channels in a communication system. In outdoor or indoor environments, the waveforms transmitted from the emitter A to the receiver B (arrow I FIG. 1) and to the third party E (arrow II FIG. 1) take multipath routes. The signals may be reflected by obstacles at different angles of reflection. One portion of the signals SAB may be received by Bob, while another portion, after diffraction SAE, will be received at the unauthorized third party E. On account of the complexity in the propagation of the waves and of the unpredictable diffractions in the communication channel, the third party E is a priori incapable of predicting or of recovering the measurements of the propagation channel between the emitter A and the receiver B so as to communicate. It is notably this characteristic that the method according to the invention will use. The channels measured by Alice and by Bob and the coefficients that they will extract therefrom, after appropriate quantification and formatting that are described hereinafter, characterize the ‘legitimate’ authorized links and are not able to be known or reconstructed by the third party E.

With the transceivers Alice A and Bob B wishing to communicate completely securely, A and B wish to extract a shared secret key K_{A}, based on the parameters of the propagation channel that each measures. For example, when the unauthorized third party Eve E is situated at a distance of a few wavelengths from B, the measurements of the channel will still be independent of the legitimate channel and, in fact, the key K_{E} that E will be able to extract will be independent of the secret key K_{A} extracted by A and B. In many cases, a distance of a few wavelengths is enough to ensure independence between the keys K_{A} and K_{E}.

Considering exchanges between users A and B in temporal duplex mode (emission and reception on the same carrier frequency in the direction A to B and B to A), the invention utilizes the natural reciprocity of the propagation channel (during its period of stationarity) insofar as the angles of incidence and the lengths of the outward and return paths are the same.

Considering exchanges between users A and B in frequency duplex mode (emission and reception on different carrier frequencies depending on the direction A to B or B to A), implementing the invention involves duplicating, on each carrier, the steps of the method described hereinafter to take advantage of the natural reciprocity of the propagation channel on each of the carriers.

With the aim being to generate a secret key to protect the data exchanges between the transceiver A and the transceiver B, the method will implement, for example, the following steps:
a) The first step consists in measuring the signals emitted by each emitter 16e of a first user A after reception of the signals at each receiver 26r of the second user B, in estimating the parameters of the corresponding propagation channels, and then in calculating the complex frequency or time responses (with amplitude and phase information) of the corresponding channels. These estimations are performed by the receivers 26r of B on the emitters 16e of A and by the receivers of A 16r on the emitters 26e of B. They make it possible to obtain the values of the parameters of the propagation channels, for example the complex impulse responses and/or complex frequency responses of said propagation channels;
b) In a second step, the method uses an algorithm executed on the calculating unit 11, 12 of each of the users A and B, which makes it possible to select, in a univalent manner, the complex propagation channel coefficients resulting from the estimations performed in step a), keeping only the coefficients having a low cross-correlation lower than an adjustable predetermined threshold V_{CC}. The secret key K_{S} extracted at the end of the process will then be secret with a sufficient random nature, even in highly stationary propagation environments such as are encountered, for example, when the emitters and receivers have fixed positions and the obstacles and reflectors involved in the propagation mechanisms are themselves also fixed;
c) In a third step, called quantification and formatting, each user quantifies the selected complex channel coefficients, by applying a geometrical mesh of the complex plane, numbers the complex coefficients of the channel according to the mesh to which they belong, and formats the quantified data in an unequivocal manner in order to increase the reliability thereof using error correction techniques applied to said numbering, for example the use of two alternate quantification planes, such as introduced by Wallace. This makes it possible to minimize, a priori, the differences between the keys obtained by the legitimate users—key K_{A} obtained by A on the emissions of B and key K_{B} obtained by B on the emissions of A;
d) In an optional fourth step, called information reconciliation step, the method eliminates the remaining conflict between the key K_{A} obtained by A and the key K_{B} obtained by B. To this end, use is made for example of error correction codes and exchanges with low information disclosure, in accordance with the following description, in order to correct the errors of B on the key K_{A} of A, if K_{B} were to be different from K_{A} at the end of the preceding steps. Alice A will for example transmit, on the public channel, a message that will not disclose the value of the key K_{A} but that will allow Bob B to recover the key K_{A} from the key K_{B} that he himself determined, considered to be an imperfect approximation of K_{A}. Due to the strong decorrelation of the propagation channel between A and E and between B and E, the key extracted from the propagation channel by E on the emissions of A or of B, K_{E}, will be too different from the keys K_{A} or K_{B} calculated by A and B to allow E to recover K_{A} or K_{B};
e) An optional fifth step, called confidentiality amplification, is implemented using for example a hash function. This step will make it possible to eliminate any residual disclosure of information to an unauthorized third party E, and at the same time to improve the random nature of the secret key K_{A}. This step makes it possible to guarantee that the secret key K_{S} generated at output is independent of any key K_{E} possibly calculated by the unauthorized third party, even if E is able to capture, decode and correctly interpret all of the information exchanged between A and B.

The error correction code in reconciliation step d) may be a simple algebraic code that is well known to those skilled in the art, and the hash function used in confidentiality amplification step e) may be a 2-universal hash function family, known to those skilled in the art.

Optional steps d) and e) may be omitted when the users have sufficient guarantees as to the reliability and the secret of steps a), b) and c); in this case we have directly K_{S}=K_{A}=K_{B}.

The steps of the method summarized above will now be described in detail.

Estimation of the Propagation Channel (Step a)

The generation of a secret key K_{S} is based on the use of the information regarding the state of the propagation channel, known under the expression ‘channel state information’. This information may be measured in the frequency domain (channel frequency response (CFR) or channel transfer function (CTF)), denoted H_{f} hereinafter, or in the temporal domain (channel impulse response or CIR), denoted Hₜ hereinafter.

In the frequency domain, the estimation of the channel H_{f} quantifies the fading applied to each sub-carrier.

In a system in which the signals are appropriately (i.e. in accordance with the rules known to those skilled in the art—compliant with the Nyquist criterion) filtered and sampled in baseband with a period T_{ech}, considering a finite-bandwidth channel response, the k^{th} component of the sampled CFR response Ĥ_{f}(k) corresponding to the frequency fₖ=k/T_{ech} is calculated using the formula:

$${\hat{H}}_{f} ( k ) = \frac{Y ( {f}_{k} )}{X ( {f}_{k} )}$$

where Y(fₖ) is the received signal in the frequency domain at the frequency fₖ, and X(fₖ) is the emitted signal or the reference signal in the frequency domain at the frequency fₖ.

This method is particularly well-suited to multicarrier waveforms using orthogonal frequency division multiplexing or OFDM, for example WiFi, LTE or Bluetooth.

The sampled CFR response Ĥ_{f}(k) may also be obtained by directly utilizing the outputs of the processing operations applied in the frequency domain by the receivers of each user for the needs specific to the quality of their reception and demodulation of the signals emitted by the other users: equalization on pilot sub-carriers in the nodes, base stations and terminals employing techniques for the radio-based accessing of the OFDM modulations and associated protocols, for example of O-FDMA (orthogonal-frequency division multiple access) or SC-FDMA (single carrier-frequency division multiple access) type, such as in radio broadcast networks using the DVB-T (Digital Video Broadcast-Terrestrial) standard, or fourth-generation cellular radio networks using the LTE (Long Term Evolution) standard, these techniques being well known to those skilled in the art.

In the temporal domain, the estimation of the channel Hₜ quantifies the distribution of the propagation paths over time in the band of the carrier of the signal. In the example given, considering a finite approximation of the temporal response of the channel, the I^{th} sample of the sampled CIR response Hₜ(l), corresponding to the instant tₗ=I.T_{ech}, the sampled CIR response Hₜ(l) is obtained, for example, from the sampled CFR response using the inverse fast Fourier transform as follows:

Hₜ=IFFT(Ĥ_{f}).

It may also be obtained directly in the temporal domain from reference signals xA(t+t0) and x_{B}(t+t₀) emitted by the users A and B, from a reference instant t₀, and by applying, to the signals y_{A}(t+t₀) and y_{B}(t+t₀) received by the receivers of the users A and B after propagation in the transmission channel, for which a finite length L approximation is considered, the following steps:
appropriate filtering and sampling (compliant with the Nyquist criterion known to those skilled in the art) in baseband with the period T_{ech} producing the sampled signals y_{A}(I+I₀) and y_{B}(I+I₀), the indices I and I₀ being defined by t=I.T_{ech}; t₀=I₀. T_{ech}, using one or more finite-response filter estimation methods (methods known to those skilled in the art), in order for example to estimate the coefficients Hₜ(l₁), l₁=0, . . . ,L−1 by minimizing a non-linear function that reflects, over a period of integration of L samples, the quadratic estimation error between the received sampled signal y(I+I₀) and the emitted sampled signal x(I+I₀) filtered by the sampled propagation channel Hₜ={Hₜ(l₁)ₗ_{₁}_{=0, . . . ,L-1}}.

Such a function is explained in the following formula:

$$\{ {{H}_{t} ( {l}_{1} )}_{{l}_{1} = 0 , … , L - 1} \} = {ArgMin}_{\{ {h ( {l}_{1} )}_{{l}_{1} = 0 , … , L - 1} \}} {\{ {\sum }_{l = 0}^{{L}^{′} - 1} ‖ y ( {l}_{0} + l ) - {\sum }_{{l}_{1} = 0}^{L - 1} h ( {l}_{1} ) x ( {l}_{0} + l - {l}_{1} ) ) ‖}^{2} \} \qquad$$

The sampled CIR response Hₜ(l) may also be obtained by directly utilizing the outputs of the processing operations applied in the temporal domain by the receivers of each user, for the needs specific to the quality of their reception and demodulation of the signals emitted by the other users:
equalization on pilot sequences in the nodes, base stations and terminals employing techniques for the radio-based accessing of TDMA (time division multiple access) protocols, such as in second-generation networks using the GSM (Global System Mobile) standard,
RAKE radio reception in the nodes, base stations and terminals employing techniques for the radio-based accessing of CDMA (code division multiple access) protocols, such as in third-generation networks using the UMTS (Universal Mobile Terrestrial System) standard,
   these techniques being known to those skilled in the art.

### Channel Decorrelation (Step b)

The secret keys K_{S} that are generated should preferably be completely random so as to be unpredictable to the unauthorized third party E. To this end, the second step of the method (step b) uses a selection algorithm in the temporal and frequency domains that makes it possible to retain only the decorrelated channel coefficients that is to say that have the ability to generate digital data or bits with equal and uncorrelated probability distributions.

In order to eliminate the temporal and frequency correlation, the method may, for example, implement one or the other of the algorithms described hereinafter.

It is possible to use an algorithm for reducing the temporal correlation between the channel coefficients. The set of channel coefficients measured at one and the same acquisition instant t constitutes a temporal frame. The temporal coefficients of cross-correlation C_{cc,t} are calculated between two consecutive frames Rᵢ, Rᵢ₊₁ using algorithms known to those skilled in the art. The method selects the frames for which the coefficient of cross-correlation C_{cc,t} is lower than a threshold value Tₜ.

It is also possible to use an algorithm for reducing the frequency correlation between the coefficients of the channel. The method is explained below, by way of illustration and without limitation, for an OFDM (orthogonal frequency division multiplexing) sub-carrier-modulated signal. For such a signal, the frequency coefficients of cross-correlation C_{cc,f} are calculated between two consecutive carrier frequencies Pⱼ, Pⱼ₊₁ using algorithms known to those skilled in the art. The method selects the carriers for which the coefficient of cross-correlation C_{cc,f} is lower than a threshold value T_{f}. In addition, the lowest-frequency and highest-frequency sub-carriers are eliminated. The method would apply in the same way to the complex spectral components of a general signal, at the outputs of a Fourier transform of said signal performed in accordance with the rules of the art.

Finally, Alice will transmit to Bob the temporal t and frequency f indices of the selected channel coefficients, using the public transmission channel. Only the indices of these coefficients are transmitted, thereby not leading to any disclosure of information regarding the value of these coefficients to an unauthorized third party E.

A second algorithm for decorrelating the measurements of the channel concatenates the above two algorithms as follows: first, the temporal frames C_{cc,t} for which the coefficients of cross-correlation with all of the other frames are all lower than a fixed threshold Tₜ are preselected. Next, for the temporal frames resulting from the above preselection, the carrier frequencies for which the coefficients of cross-correlation C_{cc,f} are all lower than a fixed threshold T_{f} are selected.

### Quantification (Step c)

Assuming that the propagation channel is reciprocal and random, it may be considered to be a common source of random bits bᵢ between a pair of legitimate terminals, where i is an integer. Thus, after having measured the radio channel, the emitter 16e of A and the receiver 26r of B jointly use a quantification algorithm to generate a sequence of bits b₁, . . . b_{N} that are intended to produce a secret key from the channel common to A and B. However, on account of the presence of noise and estimation errors of the propagation channel, the emitter 16e of A and the receiver 26r of B may disagree over some bits of the secret key that is generated, that is to say that the keys K_{A} and K_{B} do not completely match. To limit this phenomenon, the method will execute a configured quantification algorithm.

One conventional example of a quantification algorithm consists in meshing the complex plane (then called quantification plane) in which the channel coefficients take their values. Conventionally, the real axis and the imaginary axis of the complex plane are partitioned into intervals, with guard bands between these intervals. The quantification algorithm assigns a complex channel coefficient with the numbers of the intervals in which its real part and its imaginary part are located, but it rejects all of the real or imaginary parts of complex coefficients that are situated outside of an interval, that is to say in one of the guard bands, this thus leading to ineffective utilization of the measurements of the channel and to a reduced amount of digital data or extracted bits.

Other models use multiple quantification planes, in which each plane is adjusted to the current frame of the channel coefficients, such as the channel quantification algorithm CQA described in the document by J. Wallace and R. Sharma, “Automatic secret keys from reciprocal MIMO Wireless channels: measurement and analysis,” IEEE Trans. on Info. Foren. and Sec., vol. 5, no. 3, pp. 381-392, September 2010. The principle that is implemented consists in choosing the quantification plane least sensitive to the conflict of the current frame of the channel coefficients.

The method according to the invention will, for example, apply a CQA algorithm to the channel coefficients in order to generate the bits of the secret key.

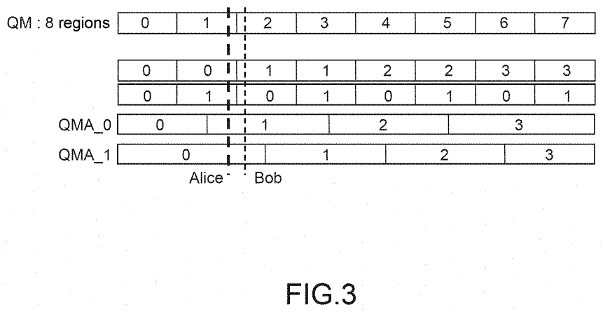

An illustrative and non-limiting example is given in FIG. 3, which illustrates the principle of the CQA algorithm. This algorithm uses two alternate planes to generate the bits of the secret key. FIG. 3 illustrates the application of the CQA algorithm with consideration to just one axis for the sake of simplicity, for example the real axis and the real parts of the complex channel coefficients.

The function of distributing the real and imaginary parts of the complex channel coefficients is used to divide the measurement space into equiprobable regions. All of these regions then constitute a first quantification plane P0. A second quantification plane P1 is obtained after translating the first one, in accordance with a model described in the abovementioned document by J. Wallace and R. Sharma. Thus, for each observation, the emitter of A chooses the quantification plane for which the measurement is furthest away from a border, so as to minimize the risk of error after quantification. Then, the emitter of A transmits, to the receiver of B, a message MA on the public channel indicating which quantification plane is the one used for each channel measurement. This message reveals only the index of the quantification plane that is used, and no information regarding the value of the channel coefficients.

In the example given in FIG. 3, the total space for the observable channel measurements is divided into eight regions QM numbered M=0 to M=7. When this division into eight regions is applied directly, the noise and estimation errors may bring about frequent ‘conflicts’ between the channel measurements of the emitter of A and of the receiver of B close to the borders between regions.

In illustrative FIG. 3, two alternate planes P0 and P1 of four regions are derived from the original map with 8 regions QM, M=1, . . . ,7. For each channel coefficient, Alice chooses the quantification plane P0 or P1 for which the channel coefficient is furthest from a border, thus reducing the probability of a conflict.

For example in FIG. 3, Alice chooses the plane P1 to quantify the channel coefficient and obtain zero as a key bit. Alice then transmits to Bob the index 1 of the selected plane P1. From this identifier, Bob also generates the zero as a key bit, using the channel measurement. Ultimately, in this example, despite a possible error between the channel measurements of A and of B due to reception and measurement noise, A and B will generate the same secret key.

### Reconciliation Step (Step d)

In the reconciliation step, the method will remove the remaining conflicts between the key generated by A, K_{A}, and the key generated by B, K_{B}, using an error correction code. The key calculated by A, K_{A}, is considered to be the secret key, and B wishes to recover the key from A, K_{A}, by correcting the key K_{B} extracted from its own channel measurements.

The reconciliation step comprises, for example, the following steps:

On the part of A:
Selecting a random word c belonging to an error correction code [symbol] ,
Calculating the message s=K_{A} c called secure sketch, a term known to
those skilled in the art, ⊕ denotes the addition modulo 2,
Transmitting the secure sketch s to Bob using the public communication channel,
   On the part of B:
Using the secure sketch s to calculate the word c_{B} belonging to the correction
code [symbol] and corresponding to the key of B, K_{B}: C_{B}=K_{B}⊕s,
c_{B} thus represents an imperfect approximation of the random word c selected by A,
Decoding c_{B} to correct the errors and recover the code word c selected by A.
B then obtains ĉ, an estimation of c,
Recovering K_{A} from the decoded code word ĉ and from the secure sketch s: [symbol] =ĉ⊕s.

The reconciliation step is successful when B manages to perfectly decode the code word c selected by Alice, that is to say when ĉ=c. B thus recovers the exact value of the key from A: [symbol] =K_{A}.

As a result, although it is transmitted on the public channel, the secure sketch allows exact recovery of the secret key K_{A} without disclosing its exact value.

However, E may also use the secure sketch to get close to the secret key K_{A}. It is then necessary to delete the information made vulnerable by sending the secure sketch on the public channel.

A final step makes it possible to remove this information leakage and to improve the quality of the secret key.

### Confidentiality Amplification Step (Step e)

As was mentioned above, the aim of this last step is to delete the information that has leaked to the third party E during the reconciliation step and to improve the random nature of the key. To achieve this result, it is possible to use hash functions.

The following example is given for a ‘2-universal’ hash function family.

A family [symbol] of functions [symbol] → [symbol] is said to be 2-universal if, for x1≠x2:

$$P r [ g ( {x}_{1} ) = g ( {x}_{2} ) ] \leq \frac{1}{\vert ℬ \vert} \qquad$$

where g is chosen randomly from [symbol] .

One way of constructing a 2-universal family is to select a random element a∈GF(2ⁿ) and to interpret the secret key K_{A} as an element of GF(2ⁿ).

The function {0, 1}ⁿ→{0, 1}^{r} assigning, to K_{A}, the r first bits of the product a.K_{A}∈GF(2ⁿ) is a 2-universal hash function family for 1≤r≤n. It should be noted that a.K_{A} is a product defined in the Galois field GF(2ⁿ).

The steps of the method described in detail above may be repeated from one data transmission to another transmission and/or regularly within one and the same transmission. The method recalculates the secret code upon each new transmission and upon each new message as a function of the strength monitoring and of the propagation fluctuations and possible bit rate adjustments.

The method may be implemented within a transmission system using a noise and beamforming protocol for the transmission of the data, the signals then being signals that are emitted and received within the framework of said artificial noise and beamforming protocol.

The signals may also be signals that are emitted and received within the framework of a simultaneous emission and reception protocol.

According to another variant embodiment, the signals used for the extraction of keys are public or non-public, covert or non-covert, self-interfering or non-self-interfering marking signals that are emitted and received within the framework of a transceiver system identification protocol or within the framework of a user authentication protocol for such a system or within the framework of a protocol for verifying the integrity of the messages emitted and received by such a system.

The emitters and the receivers of the device will be chosen for example from the following list: emitters and receivers configured for radio communication, emitters and receivers configured for acoustic transmissions, emitters and receivers configured for optical transmissions.

Advantageously, the method according to the invention makes it possible to extract a secret key in a univalent and unequivocal manner, thus allowing data exchanged between users to be protected.

1. A method for extracting keys from a propagation channel, said keys being intended to protect data exchanged between a first user A and a second user B, a user including one or more emitters and one or more receivers, the data being transmitted via the propagation channel, comprising at least the following steps:
a) measuring, by way of the receiver(s) of the first and of the second user A, B, signals S coming from each emitter of the other user, measuring a set of amplitude and phases parameters, a time of arrival, Doppler parameters, and signal to noise ratios (SNRs) of propagation paths of a corresponding complex propagation channel, via estimating corresponding complex impulse responses of the propagation channel or via estimating corresponding complex frequency responses of the propagation channel,
b) selecting, for each user A, B, a set of complex coefficients resulting from the set of amplitude and phases parameters, the time of arrival, the Doppler parameters, and the SNRs measured through the estimations of the complex impulse responses of the propagation channel or from the estimations of the complex frequency responses of the propagation channel, by retaining, from among a larger set of complex channel coefficients resulting from the estimations, the complex channel coefficients that exhibit a cross-correlation between consecutive frames or between consecutive frequencies that is lower than an adjustable predetermined threshold value,
c) quantifying and formatting, for each user, the selected complex channel coefficients, by (i) applying a geometrical mesh of a complex plane in which the selected complex channel coefficients take their value by taking into account a received SNR, (ii) numbering the selected complex channel coefficients according to the geometrical mesh to which they belong and according to measurement of at least one of a time of arrival, Doppler parameter, and SNR, and (iii) applying error correction techniques to said numbering, and
d) jointly using, for each user, digital data resulting from said quantification and from said formatting, in the form of secret keys to encrypt a string of the transmitted data.

2. The method as claimed in claim 1, using a communication mode between users, a temporal duplex mode employing one and the same carrier frequency for the emission and reception exchanges in both transmission directions.

3. The method as claimed in claim 1, duplicating over all of the carrier frequencies employed by users in frequency duplex mode employing different carrier frequencies for their emission and reception exchanges according to the transmission direction.

4. The method as claimed in claim 1, applying an error correction coding function to the keys KA, KB that are extracted by the users A, B, with minimal public transmission of information-free data from the first user to the second, in order to eliminate the differences between the keys of the first and of the second user.

5. The method as claimed in claim 1, using a hash function and a length reduction on the extracted keys that are designed to eliminate any residual leakage of information to a third party and embedded entropy test functions on the extracted keys that are designed to eliminate keys of randomness lower than a threshold and improve the random qualities of the keys.

6. The method as claimed in claim 1, wherein the steps are repeated from one data transmission to another and regularly within one and the same transmission.

7. The method as claimed in claim 1, wherein use is made of a noise and beamforming protocol for the transmission of the data, and in that the signals are signals that are emitted and received within the framework of said artificial noise and beamforming protocol.

8. The method as claimed in claim 1, wherein the signals are signals that are emitted and received within the framework of a simultaneous emission and reception protocol.

9. The method as claimed in claim 1, wherein the signals are public or non-public, covert or non-covert, self-interfering or non-self-interfering marking signals that are emitted and received within the framework of a transceiver system identification protocol or within the framework of a user authentication protocol for such a system or within the framework of a protocol for verifying the integrity of the messages emitted and received by such a system.

10. The method as claimed in claim 1, using emitters and receivers configured for radio communication.

11. The method as claimed in claim 1, wherein the emitters and receivers are configured for acoustic transmissions.

12. The method as claimed in claim 1, wherein the emitters and receivers are configured for optical transmissions.

13. A device for extracting keys from a propagation channel, said keys being intended to protect data exchanged between a first user and a second user, a user A, B including one or more emitters and one or more receivers, the data being transmitted via the propagation channel, wherein the one or more emitters and the one or more receivers are configured to execute the steps of the method as claimed in claim 1.

14. The device as claimed in claim 13, wherein the emitters and the receivers are radio communication transceivers.

15. The device as claimed in claim 13, wherein the emitters and the receivers are acoustic transmission transceivers.

16. The device as claimed in claim 13, wherein the emitters and the receivers are optical transmission transceivers.
